(19) United States
(12) Patent Application Publication
(10) Pub. No.: US 2026/0096684 A1
(43) Pub. Date: Apr. 9, 2026

(54) BEVERAGE OR FOODSTUFF PREPARATION SYSTEM

(71) Applicant: SOCIÉTÉ DES PRODUITS NESTLÉ S.A., Vevey (CH)

(72) Inventor: André NOTH, Pully (CH)

(21) Appl. No.: 19/115,419

(22) PCT Filed: Sep. 28, 2023
(86) PCT No.: PCT/EP2023/076985

§ 371 Date: Mar. 26, 2025

(30) Foreign Application Priority Data
Sep. 30, 2022 (EP) 22198969.2

(51) Int. Cl. A47J 31/44; A47J 31/52

(52) U.S. Cl. CPC A47J 31/4492; A47J 31/52

(57) ABSTRACT

A system comprising: a container for containing a precursor material for use with a machine for preparing a beverage and/or foodstuff or a precursor thereof, the container including a plurality of machine-readable codes, each code storing preparation information for use with a preparation process performed by said machine, each code comprising a plurality of units defining a data portion arranged at a predetermined position with respect to a reference portion, the reference portions of adjoining codes arranged to define vertices of a quadrilateral with at least two equal sides; a machine for preparing a beverage and/or foodstuff or a precursor thereof, the machine including: a processing unit for processing precursor material of the container, and; electrical circuitry to control the processing unit based on preparation information read from the code, and; a code reading system to read the code of the container by obtaining, with an image capturing device, a digital image of the code which is equal angular quadrilateral in shape; wherein the container and code reading system are configured to obtain the quadrilateral shaped digital image arranged oblique to said quadrilateral defined by the adjoining codes with said digital image to comprise at least two reference portions of the codes.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine to define a recipe, and; the recipe is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

WO2016173737A1, referring to FIGS. 4A and 4B thereof, disclose an implementation of multiple codes which are used to encode preparation information. It is desirable to maximise a number of codes captured in a digital image so that an average of the codes may be taken and/or so that more than one code may be used as a reference to accurately locate the data encoded by one of the codes. It is also desirable to maximise a size of the codes in the captured in a digital image so that they can be read as accurately as possible. However, these two conditions are at odds with each other, it is not possible to maximise one without the other.

Therefore, in spite of the effort already invested in the development of said systems further improvements are desirable.

### SUMMARY

The present disclosure provides a system comprising a container and a machine for preparing a beverage and/or foodstuff or a precursor thereof.

In embodiments, container is for containing a precursor material for use with a machine for preparing a beverage and/or foodstuff or a precursor thereof, the container including a machine-readable codes each code storing preparation information (which may be identical) for use with a preparation process performed by said machine.

In embodiments, the container includes a body portion that has a storage portion for containing the precursor material and a closing member to close the storage portion. In embodiments, the code is arranged on the closing member. In embodiments, the storage portion includes a cavity that extends in a depth direction from the closing member. The container may have a maximum depth that is less than its diameter, which can be measured at the opening of the storage portion. In embodiments, the body portion includes a flange portion that connects the storage portion to the closing member. In embodiments, the cavity of the storage portion extends in a depth direction from the flange portion. The flange portion may present a generally planar peripheral rim for receiving the closing member. In embodiments, the flange portion is planar. As used herein the term “planar” in respect of the flange portion may refer to the flange portion arranged to extend entirely with the lateral and longitudinal directions, or substantially with said directions (e.g. with major components in these directions as opposed to a depth direction). In embodiments, the container is alternatively implements as a packet. In embodiments, the body portion is formed of walls that are joined at seams and/or folded (e.g. for a container arranged as a packet).

In embodiments, the machine includes a code reading system to read the code of the container; a processing unit for processing precursor material of the container, and; electrical circuitry to control the processing unit based on preparation information read from the code. The code reader may include an image capturing device (e.g. a camera) and an outermost aperture (e.g. a reading window). An outermost portion of the code reader may be referred to as a reading head.

In embodiments, each code comprises a plurality of units defining a data portion arranged at a predetermined position with respect to a reference portion, the reference portions of adjoining codes arranged to define vertices of an quadrilateral with at least two equal sides. In embodiments, the code reading system is configured to read the code of the container by obtaining, with an image capturing device, a digital image of the code which is equal angular quadrilateral in shape. In embodiments, the container and code reading system are configured to obtain the quadrilateral shaped digital image arranged oblique to said quadrilateral defined by the adjoining codes with said digital image to comprise at least two reference portions of the codes.

By arranging the quadrilateral shape (e.g. a square or rectangle) defined by the codes as observed within the quadrilateral shape (e.g. a square or rectangle) of the digital image oblique (e.g. at an angle to rather than aligned to) the quadrilateral shape of the digital image, it may be ensured that whilst arranging the codes to be as large as possible in the digital image, at least two or at least three reference positions of the codes are always (e.g. independent of the position in which the digital image is taken in an array of repeating said code arrangement) fully located within the bounds of the quadrilateral shape of the digital image, which may avoid a condition where only one reference position is arranged in the quadrilateral of the image which can occur if the quadrilaterals are aligned. In this manner the two or more reference positions may be both (or all) used to locate the data portions, thereby enabling more accurate reading of the data portions. The condition of only being able to use a single reference portion to locate a data portion may therefore be avoided.

In embodiments, the plurality of codes are arranged as a series of repeating patterns, e.g. over all or a substantial portion (e.g. at least 80 or 90%) of a surface of the container.

As used herein, an “equal angular quadrilateral” in shape may refer to a square or rectangular shaped quadrilateral.

As used therein the term “oblique” may refer to an angle which is other than aligned, including 45 degrees or angel 20-70 degrees.

As used herein the term “alignment” in respect of an alignment between the quadrilateral shape of the digital image and the quadrilateral shape defined by the reference portions of the codes may refer to the angle between the sides, including the major sides (i.e. the longest sides). Where all sides are equal in length, it may refer to the angle between the proximal most sides. Where the quadrilateral is equal angled, it may refer to the angle between the proximal most sides. Alignment can be considered in respect of a plane in which the image is take, e.g. it may be assumed that the codes are arranged on a plane perpendicular to a central direction of projection of the camera, e.g. flat in the image, including substantially flat.

As used herein the term “quadrilateral” in respect of the digital image may include a shape of the digital image derived due to any one or more of: a quadrilateral shaped image sensor; a quadrilateral shaped lens; a quadrilateral shaped window e.g. in combination with other shaped lenses, and; other like arrangement that result in a quadrilateral shaped image for processing.

As used herein a reference portion of a code defining a “vertex” of the quadrilateral may refer to a vertex being virtually positioned at a suitable point of reference of the reference portion which is the same for each of the reference portions, e.g. a geometric centre of the reference portion or a geometric centre of the code, which the reference portion is positioned over or about, or other position.

As used herein the “digital image to comprise at least two reference portions of the codes” may refer two or more reference portions that are fully contained within the bounds of the quadrilateral shape of the digital image.

In embodiments, the quadrilateral shape defined by the code has a smaller side length than a slide length of the quadrilateral of the digital image. By implementing a side length (e.g. a major length or both side lengths) of the quadrilateral of the code to be less than a side length (e.g. a major length or both side lengths) of the quadrilateral of the digital image, the code can fit (e.g. fully) within the digital image such that it can be read in its entirety.

In embodiments, each code is arranged within a square planform and the codes are arranged to adjoin each other. By arranging the codes to be square and to adjoin (including directly adjoin such that the codes bound each other) the codes are compactly arranged (e.g. in a tessellating manner) such that more than one code may be read in the digital image. Reading more than one code may increase accuracy since an average of the encoded information maybe taken from both codes.

In embodiments, a vertex of a code is adjoined by either three or two other codes. By arranging the codes in a grid or offset grid, the codes are compactly arranged (e.g. in a tessellating manner) such that more than one code may be read in the digital image.

In embodiments, a side length of the quadrilateral shape of the digital image is at least twice that of a side length of the code. By implementing a side length (e.g. a major length) of the quadrilateral of the digital image to be at least twice that of a side length (e.g. a major length) of the code, at least two codes may fit in the digital image.

In embodiments, the oblique arrangement comprises the quadrilateral defined by the codes arranged at 45 degrees (including substantially at 45 degrees, which may include ±5% or ±10%) to the quadrilateral shape of the digital image. By implementing the quadrilateral of the digital image arranged at 45 degrees to the codes, it maybe be ensured that at least two reference portions of the code lie within the digital image.

In embodiments, the electrical circuitry is configured to locate at least one data portion using the at least two reference portions. By using a reference portion of a code for which a data portion thereof is read together with at least one reference portion of an adjoining code in the quadrilateral shape of the digital image, said data portion which is read may be located and therefore read with high accuracy.

In embodiments, the quadrilateral of the digital image and the quadrilateral defined by the codes are configure such that if aligned to each other (i.e. and not oblique), only a single reference portion may be arranged in the digital image. By implementing a size of quadrilateral of the digital image to be large enough so that it is possible to capture only a single full reference portion if the quadrilateral were alternatively aligned (e.g. with at least one side of one quadrilateral parallel to an adjoining side of the other quadrilateral) to each other, which is not the case when they are oblique, as size of the code in the digital image may be maximised which may improve reading accuracy.

In embodiments, the quadrilateral defined by the adjoining codes is arranged oblique to an edge of the container (e.g. an edge of a packet), which the code reading system is configured to use for alignment when obtaining the digital image. By arranging the codes to be oblique to an alignment edge (e.g. a peripheral edge that the container is aligned to when reading by the code reading system) of a container it may be ensured that the code is oblique to the digital image.

As used herein the term “based on” in respect of the preparation information and control of the processing unit may refer to a direct relationship (e.g. a value of a parameter of a recipe is encoded directly on the code) or a rule is used via a stored relationship to look up one or more of said values using the preparation information as an identifier. As used herein the term rule may refer to a relationship between the encoding distance and the value of the parameter. In particular it may refer to a numerical equation rather than parameters for input into the number equation. For example, the rule may be whether the relationship is linear or non-linear rather than just parameters defining the linearity.

In embodiments, the data portion is arranged at a predetermined position (e.g. which is stored on the electronic memory) with respect to a reference portion, wherein the data portion (including at least part) is arranged on an encoding line D, and a data unit is arranged a distance d from a starting position along the encoding line D as a variable to at least partially encode a parameter value of the preparation information.

In embodiments, the distance (d) may be any continuous distance from the start position or as a discrete predefined position. In embodiments, there are a plurality of encoding lines and the data portion is arranged as one or more individual data portions on each of the plurality of encoding lines.

In embodiments, the reference portion is arranged to define a linear reference line (L), and the encoding line is circular and is arranged to intersect the reference line (L). By implementing a circular encoding line, the data portions may be compactly arranged, including with varying priority depending on the radial location of the encoding line on which they are located, e.g. a greater radial position may have greater encoding accuracy due to the greater circumferential distance.

With a circular encoding line, the geometric distance that encodes the value of a parameter of the preparation information may be: the actual distance, e.g. the circumferential distance from the start portion to the data unit; the angular distance defined by the angle between the start position and data unit; another geometric quantity related to any of the aforementioned.

In embodiments, the electrical circuity is configured to obtain a parameter value from at least two different codes and determined the parameter value as an average thereof. By determining the parameter value based on more than one code, arbitrary errors that may have occurred when obtaining either parameter values from each of the codes may be reduced. The electrical circuitry may be configured to execute this step prior to correcting the parameter value with the stored preparation information.

The present disclosure provides a machine for preparing a beverage and/or foodstuff or a precursor thereof from the container of any preceding embodiment or another embodiment disclosed herein.

In embodiments, the machine comprises: a code reading system to read a code of a container; a processing unit for processing precursor material of the container, and; electrical circuitry to control the processing unit based on preparation information read from the code.

In embodiments, the processing unit includes a container processing unit and a fluid processing system, and; the electrical circuitry is arranged to control the container processing unit and fluid processing system based on the preparation information read from the code.

In embodiments, the processing unit is arranged as a loose material processing unit, and; the electrical circuitry is arranged to control the loose material processing unit to process loose precursor material dispensed from the container or arranged in the container based on the preparation information read from the code.

In embodiments, the electrical circuitry of the machine includes electronic memory to store corresponding preparation information, which is based on one or more prior reads of a corresponding code of a container. In embodiments, the electrical circuitry of the machine implements a method of reading preparation information from a code as disclosed herein.

The present disclosure provides a container for containing a precursor material for use with a machine for preparing a beverage and/or foodstuff or a precursor thereof, the container including a plurality of machine-readable codes (which may be formed directly on the container or on an attachment/substrate for attachment to the container), each code storing preparation information for use with a preparation process performed by said machine, each code comprising a plurality of units defining a data portion arranged at a predetermined position with respect to a reference portion, the reference portions of adjoining codes arranged to define vertices of a quadrilateral with at least two equal sides. In embodiments, the quadrilateral defined by the adjoining codes is arranged oblique to an edge of the container.

The present disclosure provides a substrate for attachment to: a container for containing a precursor material for use with a machine for preparing a beverage and/or foodstuff or a precursor thereof, or; for attachment to a machine for preparing a beverage and/or foodstuff. The substrate comprising a codes comprising any feature of the codes of the preceding embodiments or another embodiment disclosed herein. The substate may be configured for attachment to the container with the quadrilateral defined by the adjoining codes arranged oblique to an edge of the container, e.g. the substate may have an edge that when aligned to an edge of the container said oblique arrangement is provided. The substrate may be configured for attachment to the machine with the quadrilateral defined by the adjoining codes arranged oblique to an alignment edge of the machine, e.g. the substate may have an edge that when aligned to an edge of the machine said oblique arrangement is provided.

The present disclosure provides use of the container of any preceding embodiment or another embodiment disclosed herein for a machine for preparing a beverage and/or foodstuff or a precursor thereof according to any preceding embodiment or another embodiment disclosed herein.

The present disclosure provides a method of reading preparation information from a code for use in a preparation process, in which a machine is controlled based on the preparation information to prepare a beverage and/or foodstuff or precursor thereof. The method may implement the features of any preceding embodiment, or another embodiment disclosed herein.

In embodiments, the method comprises arranging codes of a container that encode preparation information with reference portions for location of a data portion arranged to define vertices of a quadrilateral with at least two equal sides; obtaining a digital image of the codes which is equal angular quadrilateral in shape and is arranged oblique to the quadrilateral defined by the codes; identifying at least two reference portions in the digital image; locating at least one data portion using the at least two or three reference portions, and; reading the data from the at least one located data portion.

The present disclosure provides electrical circuitry to implement the method of the preceding embodiments, or another embodiment disclosed herein.

The present disclosure provides a computer readable medium comprising program code, which may be executable on one or more processors, to implement the method of the preceding embodiments or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff.

FIG. 2 is a block system diagram showing an embodiment machine of the system of FIG. 1.

FIG. 3 is an illustrative diagram showing an embodiment fluid conditioning system of the machine of FIG. 2.

FIGS. 4 and 5 are illustrative diagrams showing an embodiment container processing system of the machine of FIG. 2 on open and closed positions.

FIG. 6 is an illustrative diagram showing an embodiment machine of FIG. 2, which comprises a loose material processing unit.

FIG. 7 is a block diagram showing embodiment control electrical circuitry of the machine of FIG. 2.

FIGS. 8 and 9 are illustrative diagrams showing embodiment containers of the system of FIG. 1.

FIG. 10 is flow diagram showing an embodiment preparation process, which is performed by the system of FIG. 1.

FIG. 11 is a plan view showing an embodiment code of the containers of the system of FIG. 1.

FIGS. 12 and 13 are flow diagrams showing embodiment processes for extracting preparation information from the code of FIG. 11.

FIGS. 14 and 15 are plan views showing embodiments arrangements of the code of FIG. 11.

FIG. 16 is a plan view showing the embodiment container of FIG. 9, comprising the codes of figure.

FIGS. 17 and 18 are plan views showing embodiments arrangements of the code of FIG. 11 with a digital image superimposed thereon.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical; packet; other like form. The container may be formed from various materials, such as metal or plastic or paper or a combination thereof. The material may be selected such that it is one or more of: food-safe; it can withstand the pressure and/or temperature of a preparation process, and; it is biodegradable. The container may be defined as a capsule, wherein a capsule may have an internal volume of 20-100 ml. The capsule includes a coffee capsule, e.g. a Nespresso® or Nescafé® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid (e.g. a solid suspended in a liquid); a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to to change a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “loose material processing unit” may refer to an arrangement that can process loose material of a pre-precursor material to a precursor material. The loose material processing unit may be arranged to process the pre-precursor material by one of more of the following: heating; cooling; grinding; mixing; soaking; conditioning; other processing step. The loose material may be supplied to the loose material processing unit in a container, from which it is extracted and processed.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to a storage medium that encodes preparation information. The code may be an optically readable code, e.g. a bar code. The code may be arranged as a bit code (e.g. a binary sequence of 0s and 1s encoded by the absence or presence of an element). The code may be formed of a plurality of units, which can be referred to as elements or markers. The elements may implement a finder portion and a data portion, wherein the finder portion encodes a predefined reserved string of bits that is identifiable when processing the code from the data portion, to enable location of the data portion, which encodes the preparation information. The code may be arranged as a one dimensional code, which is read by relative movement between the code and a code reader. The code reader may provide a bit stream signal or a high and low signal for processing by preparation information extraction. The code may be arranged as a two dimensional code, which is processed via a digital image obtained from a camera of the code reader. It will be understood that a code may therefore exclude a mere surface finish or branding on a container, which is not configured in any way for information storage.

As used herein the term “preparation information” may refer to one of more of: parameters as defined herein; a recipe as defined herein; an identifier, and; other information related to the operation of the machine.

As used herein, the term “parameter” may refer to a variable that is used as an input for controlling (e.g. RPM) and/or or a property of the beverage/foodstuff or a precursor thereof that is controlled by the processing unit (e.g. a fluid target temperature or volume) during the preparation process. Depending on the implementation of the processing unit said parameter may vary. Examples include: volume of a particular component of the beverage and/or foodstuff; fluid temperature; fluid flow rate; operational parameters of the processing unit, e.g. RPM of an extraction unit based on centrifugation or closing force for a hydraulic brewing unit; an order of dispensing of components of the beverage and/or foodstuff; agitation (e.g. frothing degree); any of the aforesaid defined for one or more phases, wherein the preparation process is composed of a series of sequential, discrete phases. The parameters that may be associated container processing unit that comprises a loose material processing unit, can include one or more of: grinding parameters, including intensity; heating temperature. The parameter may have a value, which may be numerical and can vary in predetermined increments between predetermined limits, e.g. a temperature of the water may vary between 60-90 degrees in 5 degree increments.

As used herein, the term “recipe” or “control data set” may refer to a combination of said parameters, e.g. as a full or partial set of inputs, that are used by the processing unit to prepare a particular beverage and/or food stuff.

As used herein, the term “preparation process” may refer to a process to prepare a beverage or foodstuff from a precursor material or to prepare a pre-precursor material from precursor material. A preparation process may refer to the processes electrical circuitry executes to control the processing unit to process said precursor or pre-precursor material.

As used herein, the term “code reading process” may refer to the process of reading the code to extract the preparation information (which can include the identifier and/or parameters). The process may include one or more of the following steps: obtaining a digital image of the code or a code signal; extracting a sequence of bits from the code; identifying a finder portion of the code in the sequence; locating a data portion using the finder portion, and; extracting the preparation information from the data portion.

### General System Description

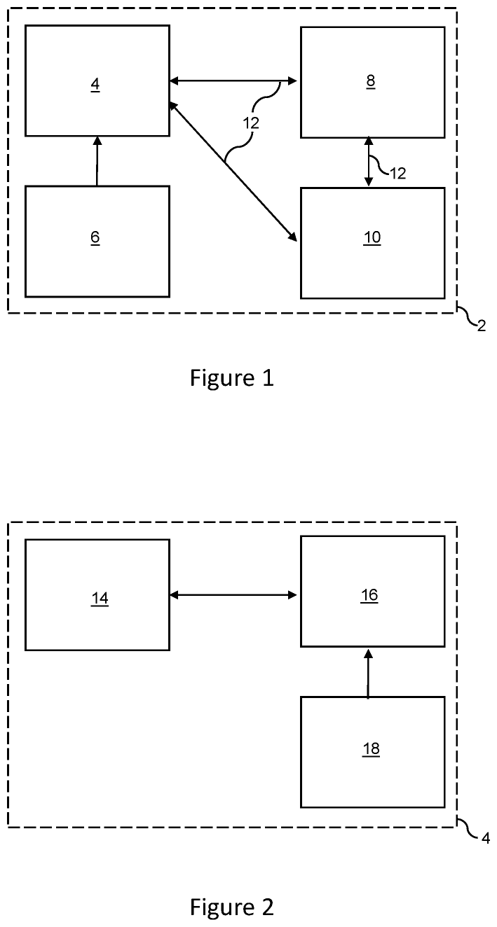

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### Machine

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### First Example of Processing Unit

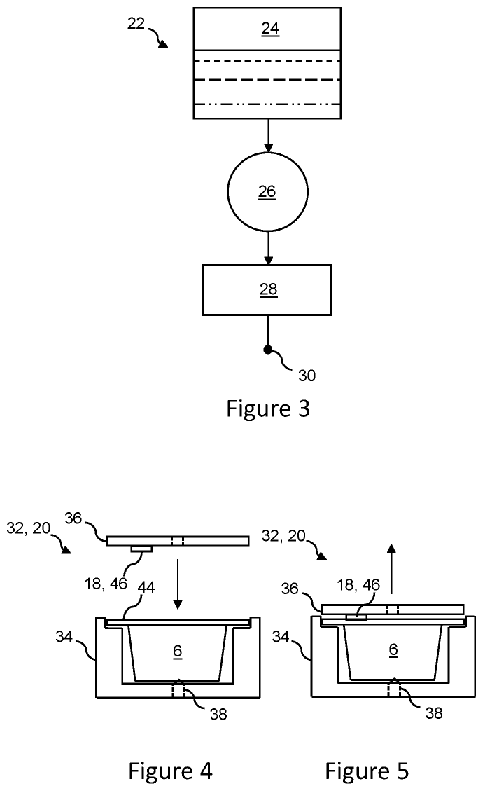

Referring to FIGS. 3, 4 and 5, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### Fluid Conditioning System

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump; the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### Container Processing Unit

The container processing unit 20 can be implemented with a range of configurations, as illustrated in examples 1-6 below. Generally, in examples where the machine 2 comprises a guide portion, in to which a container is inserted and is guided by gravity (e.g. under its own weight) to the container processing unit 20, the container processing unit 20 is arranged with a container holding portion and a closing portion, which are movable between a container receiving position and a container processing position in a depth direction, which is perpendicular (including substantially perpendicular) to a direction of transmission of the guide portion.

Referring to FIGS. 4 and 5, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4), in which capsule holding portion 34 and a closing portion 36 are arranged to receive a capsule 6 therebetween. The extraction unit 32 is movable to a capsule extraction position (FIG. 5), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 on the capsule holding portion 34 to inject the conditioned fluid into the capsule 6 in the capsule extraction position, typically under high pressure. A beverage outlet 40 on the closing portion 36 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C) fluid to the precursor material within the capsule 6. The pressure is increased over a predetermined amount of time until a pressure of a rupturing portion (not illustrated in FIGS. 4 and 5) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the capsule holding portion and closing portion, they may be alternatively arranged, including: the injection head and beverage outlet are arranged respectively on the closing portion capsule holding portion and; or both on the same portion. Moreover, the extraction unit may include both parts arranged as a capsule holding portion, e.g. for capsules that are symmetrical about the flange, including a Nespresso® Professional capsule. Examples of suitable extraction units are provided in EP 1472156 A1 and in EP 1784344 A1 and provide a hydraulically sealed extraction unit.

In a second example (which is not illustrated) of the container processing unit a similar extraction unit to the first example is provided, however the extraction unit operates at a lower pressure and by centrifugation. An example of a suitable capsule is a Nespresso® Vertuo capsule. A suitable example is provided in EP 2594171 A1. With such an example (or indeed the other examples) a guide portion may be obviated and the container manually loaded into the extraction unit.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a storage portion of the capsule. An example of a suitable capsule is a or Nescafe® Dolce Gusto capsule. Examples of suitable extraction units are disclosed in EP 1472156 A1 and in EP 1784344 A1.

In a fourth example, (which is not illustrated) wherein the container is arranged as a packet, the container processing unit implements an extraction unit operable to receive the packet and to inject, at an inlet thereof, fluid from the fluid conditioning system. The injected fluid mixes with precursor material within the packet to at least partially prepare the beverage, which exits the packet via an outlet thereof. An example of such an arrangement is provided in WO2014125123 A1 or in WO2022023578A1.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle. An example of such an arrangement is provided in EP14167344A.

### Second Example of Processing Unit

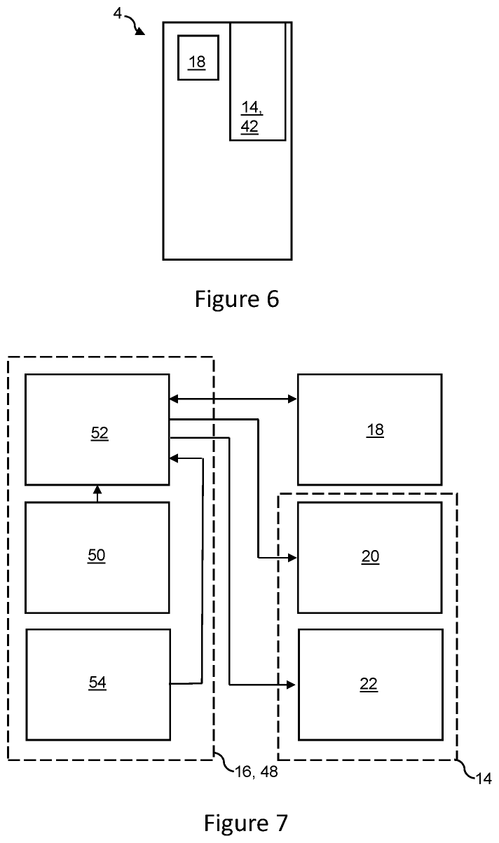

Referring to FIG. 6, in a second example of the processing unit 14, said unit comprises a comprises a loose material processing unit 42.

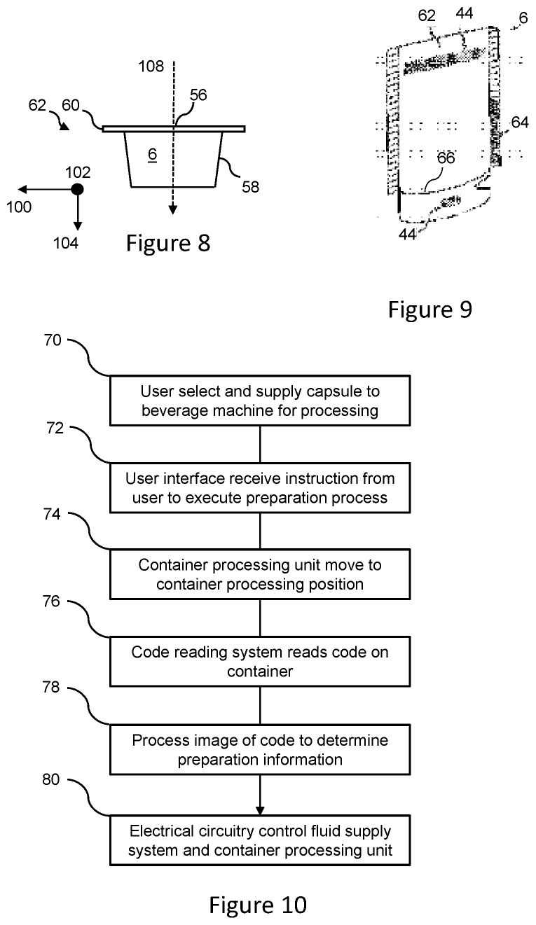

The loose material processing unit 42 is arranged to receive loose pre-precursor material from a container 6 (a suitable example is provided in FIG. 8 as will be discussed) and to process the pre-precursor material to derive the precursor material. The electrical circuitry 16 uses the preparation information read from the container 6 to control the loose material processing unit 42 to execute the preparation process.

A user resents manually the container 6 to a code reading system 18, of the machine 4, to read the code (as will be discussed). The user then opens the container 6 and dispenses the pre-precursor material (not illustrated) arranged therein into the loose material processing unit 42. The loose material processing unit 42 processes the loose pre-precursor material to the precursor material.

In a particular example, the pre-precursor material is coffee beans, and the loose material processing unit 42 is arranged to roast and/or grind the coffee beans to provide a precursor material.

In variant embodiments, which are not illustrated, the loose material processing unit is alternatively configured, including: with a dispensing system to open and dispense the pre-precursor from the capsule for subsequent processing (e.g. it may include a cutting tool to cut open the container and an extractor such as a scop to extract the pre-precursor material); the pre-precursor material may be processed in the container and either dispensed from the container by the aforedescribed example or provided to a user in the container.

### Code Reading System

Referring to FIGS. 4 and 5, the code reading system 18 is arranged to read a code 44 arranged on a lid of the container 6. The code reading system 18 is integrated with the extraction unit 32 of first example of the container processing unit 20. The code 44 is read with the extraction unit 32 in the capsule extraction position (as shown in FIG. 4).

The code reading system 18 includes a code reader 46 with an image capturing unit and a reading head housing the image capturing unit to capture a digital image of the code 44. Examples of a suitable image capturing unit include a Sonix SN9S102; Snap Sensor S2 imager; an oversampled binary image sensor; other like system.

The electrical circuitry 18 includes image processing circuitry (not illustrated) to identify the code in the digital image and extract preparation information. An example of the image processing circuitry is a Texas Instruments TMS320C5517 processor running a code processing program.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is arranged to read a code at a different location of the container, e.g. on a flange or containment portion. In further variant embodiments, which are not illustrated, the code is a one dimensional code and is read by relative movement between the code reader and the code to produce a code signal.

### Control Electrical Circuitry

Referring to FIG. 7, the electrical circuitry 16 is implemented as control electrical circuitry 48 to control the processing unit 14 to execute a preparation process. In the embodiment of FIG. 7, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 50 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule.

### Container

Referring to FIG. 8, a first example of a container 6, that is for use with the first example of the processing unit 14 comprises the container 6 arranged as a capsule 6. The capsule 6 includes a closing member 56 and a body portion 62, which comprises a storage portion 58, and a flange portion 60.

The storage portion 58 includes a cavity for storage of the precursor material (not illustrated). The cavity of the storage portion extends in a depth direction 104 from the flange portion 60. Referring to FIGS. 4 and 5, the storage portion 56 is perforated by the injection head 38 to supply conditioned fluid into the capsule.

The storage portion 58 is formed from a paper based material. The storage portion 58 has a thickness of 0.2 mm. The closing member 56 is formed from a paper based material. The closing member 58 has a thickness of 0.15 mm.

As used herein “paper based” may refer to as being formed at least partially from a thin sheet material produced by mechanically or chemically processing cellulose fibres derived from one or more of: wood; rags; grasses, or; other vegetable sources, in water, draining the water through fine mesh leaving the fibre evenly distributed on the surface, followed by pressing and drying.

The closing member 56 closes and may hermitically seal the storage portion 58 and comprises a flexible membrane. Referring to FIGS. 4 and 5, the closing member 56 is perorated to eject the beverage/foodstuff.

The flange portion 60 is formed integrally with the storage portion. The flange portion 60 is arranged at the junction of the storage portion 58 and closing member 56 and comprise a planar extension of the storage portion 58 that is overlapped by a portion of the closing member that is fixed thereto to hermetically seal the precursor material. The flange portion 60 extends in a plane defined by a lateral direction 102 and a longitudinal direction 100. Hence the closing member is planar in said plane.

The capsule 6 is circular cross sections such that it is rotationally symmetric about axis 108. In this way a user can present the capsule to the machine 2 with any orientation about the axis 108. The capsule 6 has a diameter of 53 mm, which is measured across an outer or inner periphery of the flange portion 60 in said plane of the flange portion 60. The capsule 6 can be configured with different sizes, which are characterised by different depths e.g.: 7 mm; 12 mm; 15 mm; 18 mm, and; 21 mm. The capsule 6 in each size is compatible with the first and second examples of the code reading system 18 as will be discussed.

In variant embodiments, which are not illustrated, the closing member may be arranged as convex or concave with respect to the storage portion. For example, for a convex arrangement, a centre of the closing member may extend into the storage portion in the depth direction by up to 1 mm±10% or 20%. A minimum concavity maybe 0.2 mm. For example, for a concave arrangement, a centre of the closing member may extend away from the storage portion in the counter depth direction by up to 4 mm±10% or 20%. A minimum concavity maybe 0.5 mm.

In variant embodiments, which are not illustrated: the body portion comprises the flange portion formed non-integrally with the storage portion and connected thereto; the body portion comprises the flange portion omitted, e.g. the closing member is wrapped around the storage portion; the container may be a non-rotationally symmetric shape, e.g. square sectioned or other shape; the capsule is alternatively dimensioned, including across an outer or inner periphery of the flange portion is 40-70 mm or 53 mm±10% or 20% and the depth is any of the described depths±10% or 20%; the thickness of the storage portion may have a thickness of 0.1 to 0.4 mm or 0.2±20% or 30%; the thickness of the closing member may have a thickness of 0.05 to 0.3 mm or 0.15±20% or 30%, and; the storage portion and/or closing member may be made out of or include a different material, e.g. including a plastics or aluminium based material.

Referring to FIG. 9, a second example of a container 6 that is for use with the second example of the processing unit 14 comprises the container 6 arranged as a packet and includes: an arrangement of sheet material 62 joined at peripheral seams 64 defining an internal volume for the storage of the precursor material (not illustrated), and; an opening 66, that a user opens to dispense the precursor material into the loose material processing unit 42.

### Arrangement of Code

Referring to FIG. 8, the code 44 code may be arranged on an exterior surface of the container 6 in any suitable position such that it can be read by the code reading system 18.

In an first example, the code 44 is arranged at a central region of the closing member 56. The code can therefore be read by any code reader that is aligned to the centre of the container. In an second example, the code is reproduced over the entire closing member so that it can be read from any exterior position on the closing member 56. With such an arrangement the closing member does not require any specific alignment with the storage portion, which simplifies cutting and assembly processes for the container 6.

In variant embodiments, which are not illustrated, the code can be arranged on the flange portion 60 (including on either side) and on the storage portion 58. The code may also be arranged on the closing member but not on the central region.

In the second example shown in FIG. 9, the code 44 is arranged at various positions on the sheet material 62, including distal the seams 64.

### Preparation Process

Referring to FIG. 10, a process for preparing a beverage/foodstuff from precursor material is illustrated:
Block 70: a user supplies a container 6 to the machine 4.
Block 72: the electrical circuitry 16 (e.g. the input unit 50 thereof) receives a user instruction to prepare a beverage/foodstuff from precursor, and the electrical circuitry 16 (e.g. the processor 52) initiates the process.
Block 74: the electrical circuitry 16 controls the processing unit 14 to process the container (e.g. in the first example of the container processing unit 20, the extraction unit 32 is moved from the capsule receiving position (FIG. 4) to the capsule extraction position (FIG. 5)).
Block 76: the electrical circuitry 16 controls the code reading system 18 to provide a digital image of the code 6 of the container.
Block 78: the code processing circuitry of the electrical circuitry 16 processes the digital image to extract the preparation information.
Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction portion through the capsule ejection position to eject the container 6 and back to the capsule receiving position.

In variant embodiments, which are not illustrated: the above blocks can be executed in a different order, e.g. block 72 before block 70 or block 76 before block 74; some block can be omitted, e.g. where a machine stores a magazine of capsules block 70 can be omitted.

Blocks 76 and 78 may be referred to a code reading and processing process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### Code General Description

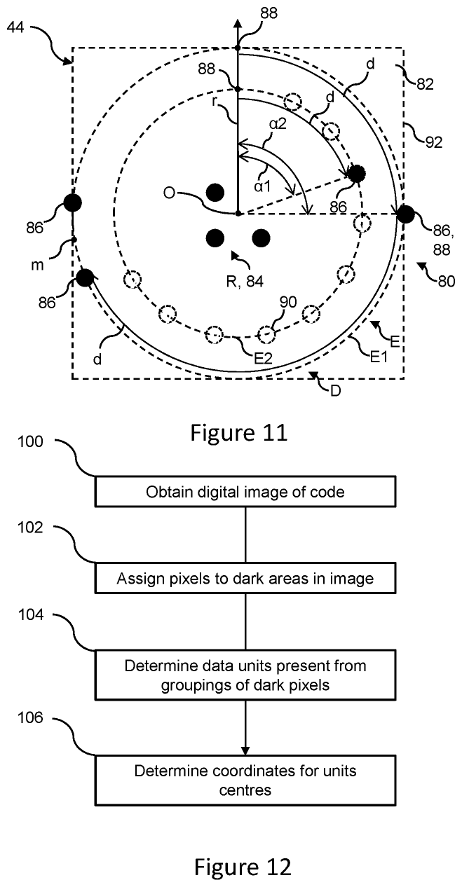

Referring to FIG. 11, the code 44 is formed of a plurality of circular units 80 arranged on a surround 82. The units 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 to distinguish therebetween. The units 80 of the code may be configured to be read in the infra red and/or visible wavebands.

The units 80 are circular in shape. As used herein the term “shape” in respect of the units may refer to an exact shape or an approximation of the actual shape, which can occur to a printing or other manufacturing variations in precision.

In variant embodiments, which are not illustrated: the units are a light colour and the surround is a dark colour; the units have a different shape including one or a combination of the following shapes, triangular, polygon, in particular a quadrilateral such as square or parallelogram; other suitable shape.

The units 80 typically have a unit length of 50-200 μm. As used herein the term “unit length” in respect of a unit 80 may refer to a suitably defined distance of the unit 80, e.g.: for a circular shape the diameter; for a square a side length; for a polygon a distance between opposing or adjacent vertices; for a triangle a hypotenuse. The units 80 are arranged with a precision of about 1 μm.

The units 80 are formed by printing e.g. by means of an ink printer. As an example of printing the ink may be conventional printer ink and the substrate may be: polyethylene terephthalate (PET); aluminium coated with a lacquer (as found on Nespresso Classic capsules) or other suitable substrate.

In variant embodiments, which are not illustrated: the units are alternatively formed, including by embossing, engraving or other suitable means, and; the units are alternatively dimensioned, e.g. a unit length of 80-120 μm.

Referring further to FIG. 11, the units 80 are organised into: a reference portion R to locate and determine an orientation of the code 44, and; a data portion D to store the preparation information.

The units 80 of the code 44, which are arranged as the reference portion R, comprise three reference units 84. The reference units 84 have a unique spatial arrangement in the code 44 to allow the reference portion R to be identified by the electrical circuitry 16 (e.g. with a stored relationship on a memory thereof) in the digital image. The unique spatial arrangement comprises the reference units 84 arrange at three of the vertices of a virtual rectangle (not illustrated), about an origin O at the centre of the rectangle, with specific distances between the reference units 84.

In variant embodiments, which are not illustrated, the reference portion is alternatively implemented, including: as a different arrangement of reference units, e.g. including as a circle or other shape of rectangle; with a different number of reference units, e.g. including as 4 or 5, and; the reference units may have a unique shape that is identifiable from the shape of the other units forming the code.

The arrangement of the reference units 84 enables the definition of a single reference line r at a specific vector relative to said units 84. The reference line r is virtual, and is determined by the electrical circuitry 16 (e.g. with a stored relationship on a memory thereof).

In the particular example, the reference units 84 define, using the right hand rule, a first virtual line (not illustrated) and a second virtual line (not illustrated), wherein: the thumb represents the first virtual line which intersects the centres of two of the refence units 84; the index finger represents the second virtual line which intersects the centres of two of the refence units, one of which being the common to the first virtual line; the second finger is into the plane of the page of the code 44. The reference line r extends from the origin O and is parallel to the first virtual line and is orthogonal to the second virtual line.

In variant embodiments, which are not illustrated, the reference line may be alternatively defined: the may comprise an actual line drawn on the code; it may have an alternative geometric arrangement with respect to the reference units.

Units 80 of the code 44, which are arranged as the data portion D, comprise data units 86. The data units 86 are arranged on an encoding line E that intersects the reference line r. The encoding line E is virtual and is determined by electrical circuitry 16, (e.g. the encoding lines have predefined radii, which are stored on a memory thereof). The centre of the circle of the encoding line E is arranged at the origin O of the reference portion R. The reference line r therefore intersects the encoding line E with a tangent thereto orthogonal to the reference line r. There are two encoding lines E1, E2, each with data units 86.

In variant embodiments, which are not illustrated: other numbers of encoding lines are implemented including 3, 4, or 5; the encoding lines may have non-circular shapes, including rectangular or triangular; the encoding line comprises an actual line drawn on the code.

The encoding line E includes one or more individual data portions, each of which includes a start position 88 and a data unit 86, which is arranged at a distance d along the encoding line E from the start position 88 as a variable to encode a parameter of the preparation information. The start positions 88 are defined virtually and may be determined by electrical circuitry 16 (e.g. the start positions may be stored on a memory thereof). The individual data portions may also include an end position (not illustrated), which defines a maximum allowable distance d of the data unit 80 along the encoding line E from the start position 88. Both the start and end positions are formed virtually.

For the first encoding line E1, the data portion includes two individual data portions: for the first individual data portion the distance d can be any continuous distance from the start position 88 at the reference line r to the first data unit 86 clockwise from the reference line r; for the second individual data portion the distance d can be any continuous distance from the start position 88 at the data unit 86 of the first individual data portion (hence the start position is variable) to the mid-point m between the subsequent two data units 86 in the clockwise direction.

For the second encoding line E2, the data portion includes one individual data portion, for which the distance d can be any one of a plurality of discrete distances, which are illustrated as discrete positions 90 from the start position 88 at the reference line r, with each position associated with a value of the parameter. In the example there are 10 discrete positions 90.

An incremented distance can be defined as the distance between the start position 88 and an end position divided by the total number of positions (which is 10 for E2) in the data portion D that the data unit 86 may occupy.

In variant embodiments, which are not illustrated: a start position can be arranged at any position on the encoding line, including spaced away from the reference line; there may be multiple start positions on an encoding line, each with an associated data unit; the start position may be formed as part of the code as a unit rather than defined virtually; an encoding line may comprise combinations of parameters encoded by the continuous distance and the discreet positions; more than one or two data units on the encoding line may define the parameter, which can be determined as an average of the positions, and; the data portion can include any suitable number of individual data portions.

The code 44 includes an outer periphery 92 that the units 80 are arranged within. The outer periphery 92 is rectangular in shape and has a dimension of 600-1600 μm, or about 1100 μm. The code 44 may be repeated such that multiple repetitions of the code 44 are arranged within a single digital image, such that one or several best captured repetitions of the code can be selected for processing.

In variant embodiments, which are not illustrated: the outer periphery may be alternatively shaped, including circular; the outer periphery may have alternative sizes, including greater or smaller than the example range. In variant embodiments, which are not illustrated, the data portion alternatively encodes the value of said parameter, including as alphanumeric symbols or other arrangement.

Referring to FIG. 12, with reference to the code of FIG. 11, a code processing process, which is executed by the electrical circuitry 16 (or the code processing circuitry thereof) for extraction of the preparation information includes:
Step 1—Identify Locations of Units of Code
Block 100: obtain digital image of code 44 via the code reading system 118.
Block 102: assign pixels to dark areas in digital image that could represent units 80.
Block 104: if several pixels grouped in proximity of each other then determine a unit 80 as present.
Block 106: for each determined unit determine a centre of pixel grouping by a rule, e.g. feature extraction, to determine a coordinate of a centre of the unit.

Invariant embodiments, which are not illustrated, alternative processing techniques for determining units and there coordinates may be implemented, including other techniques for locating a centre of a unit or identifying a unit as present, e.g. a level of magnification may be implemented so that a single pixel is determined as a unit, and a centre of a unit may be determined as the centre of a pixel.
Step 2—Locate Reference portion and read angles of code

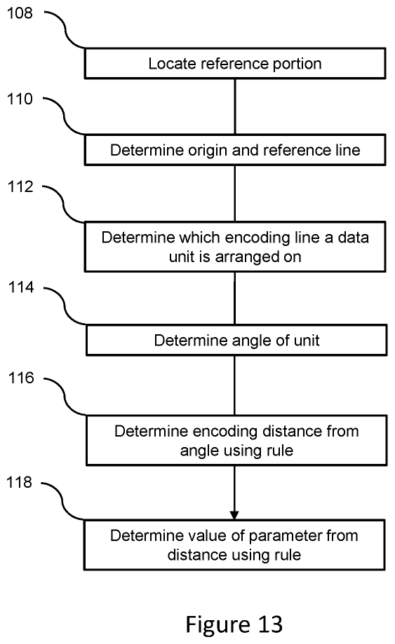

Referring to FIG. 13, with reference to the code of FIG. 11, processing of the code 44 includes:
Block 108: locate reference portion R by searching coordinates of units 80 of code 44 to identify the unique separation and geometric arrangement of reference units 84. This may be implemented by geometric rules including Pythagoras and trigonometry or other suitable rule. Said separation and geometric arrangement can be stored on the electrical circuitry 16 and accessed during searching.
Block 110: for the located reference portion R, define the origin O and the position of reference line r using a stored relationship. The arrangement of the origin and reference line can be stored on the electrical circuitry 16 and mapped onto the coordinates of the located reference portion.
Block 112: for each unit (other than the units of the reference portion) determine based on distance from the origin O which encoding line E the units belong to. The electrical circuitry 16 can store a radii range for each encoding line E and using geometric rules determine the distance of each unit from the origin O and which radii range it falls in.
Block 114: for each unit (other than the units of the reference portion) determine the angle α1, α2 with respect to the reference line r. It is to be noted that the angle is representative of the circumferential distance, and either could be used interchangeably. The angle can be calculated via know geometric relations between the coordinates of the reference line r and a virtual line extending from the origin O and through the associated unit.
Step 3—Determine values of parameters of preparation information.

Referring to FIG. 13, with reference to the code of FIG. 11 processing of the code 44 includes:
Block 116: the encoding distance d is determined for each individual data portion. This is achieved by implementing a set of rules for determining the encoding distance d which are stored by the electrical circuitry 16. This can include the one or more of: the number of individual data portions on each encoding line; the start positions 88 of the individual data portions; if a single unit or multiple units represent a data unit 86, and; other suitable relationships.

For example referring to FIG. 9, the rules for determining the encoding distances d of encoding line E1 include that there are: two individual data portions; the start position 88 of the first individual data portion is at the intersection between the reference line r and the encoding line E1; the start position 88 of the second individual data portion is at the data unit 86 of the first individual data portion; the data unit 86 is of the first individual data portion is represented as a single unit of the code 44; the data unit 86 is of the second individual data portion is represented as a two units of the code 44.

For example, referring to FIG. 11, the rules for determining the encoding distance d of encoding line E2 include that there is: a single individual data portion; the start position 88 is at the intersection between the reference line r and the encoding line E2; the data unit 86 is of the first individual data portion is represented as a single unit of the code 44.
Block 118: the encoding distances d for each data portion are converted into a value of a parameter. This is achieved by implementing a set of rules for converting the distance of a value which are stored by the electrical circuitry 16.

For example, for encoding line E1: the first individual data portion may encode a water volume of a brewing process wherein the distance d is any continuous value which is linearly related to the water volume, and; the second individual data portion may encode a time of a brewing process wherein the encoding distance d is any continuous value which is exponentially related to the time.

For example, for encoding line E2: the single individual data portion may encode a water temperature of a brewing process wherein the encoding distance d is a discrete value which incrementally changes by 5 degrees C for each discrete position 90, and the rule specifies which 5 degree increment is closest to the determined encoding distance d.

In variant embodiments, which are not illustrated, other rules can be implemented, including: other mathematical functions relating the encoding distance to the value of the parameter, and; if an encoding distance is the average of the distance several individual data portions, and other suitable relationships.

### Code Processing

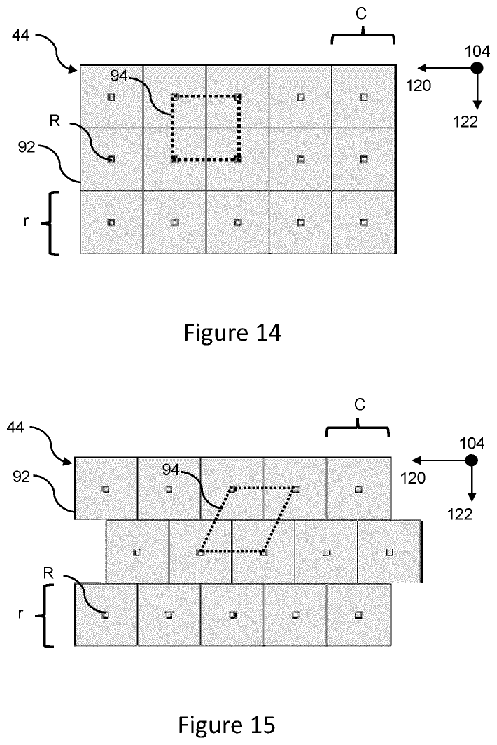

Referring to FIG. 14 in a first example the codes 44 are arranged with their outer periphery 92 directly adjoining each other. The codes 44 are arranged into aligned columns C that extend in a local lateral direction 122 and rows r that extend in a local longitudinal direction 120. Accordingly, a vertex of the outer periphery of an individual code 44 adjoins 3 other vertices of the adjoining codes 44. The codes 44 are aligned to each other as a grid formation. The reference portions R of the codes 44 are therefore arranged to define vertices of an quadrilateral 94 with at least two equal sides. In the first example the codes 44 are configured and arranged so that the quadrilateral 94 is equal angular and equal sided (a square).

In the FIGS. 14-18 , the previously described units 84 forming the reference portion R are idealised as a square central to a code 44, that is, they are contained within the square. The vertex of the quadrilateral 94 are at the origin O of the reference portion R (and code 44), although it will be appreciated that other suitable implementations can be used.

Referring to FIG. 15 in a second example the codes 44 are arranged with their outer periphery 92 directly adjoining each other. The codes 44 are arranged into aligned rows r that extend in a local longitudinal direction 120. The rows are alternating offset in the local longitudinal direction 120 by half a side length of a code. Accordingly, a vertex of the outer periphery of an individual code 44 adjoins one other vertices of an adjoining codes 44. The codes 44 are aligned to each other as an offset grid formation. The reference portions R of the codes 44 are arranged to define vertices of an quadrilateral 94 with at least two equal sides. In the second example the codes 44 are configured and arranged so that the quadrilateral 94 is equal sided but not equiangular (a rhombus or diamond).

In variant embodiments, other arrangements of the codes are implemented, including: there is a gap between directly adjoining codes; in the second example other offset rather than half a code side length is implemented; other numbers of codes than 3×5 can be implemented, for example the container may be entirely covered with the disclosed code repetitions which repeat with the same repeating arrangement.

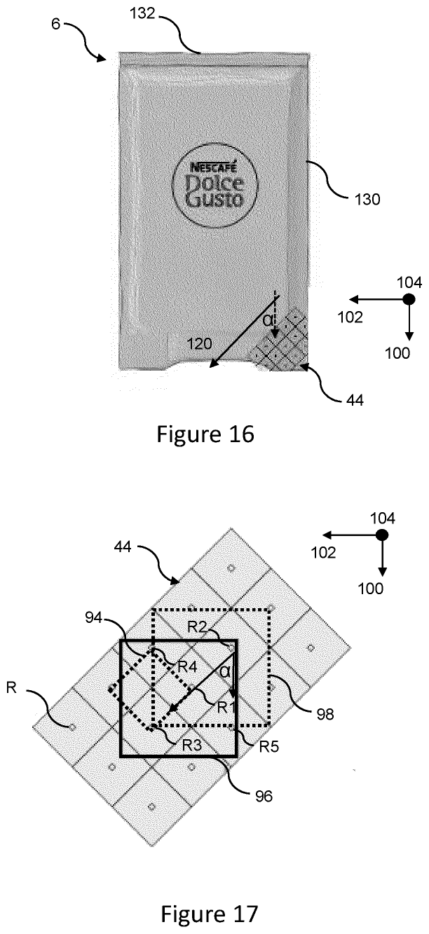

Referring to FIG. 16, codes 44 with the arrangement described in the first example are arranged with the local longitudinal direction 120 arranged at angle a oblique at 45 degrees to the global longitudinal direction 100 of the container 6. The container 6 is arranged as a packet as discussed in association with FIG. 9, with a longitudinal edge 130 aligned to the global longitudinal direction 100 and a lateral edge 132 aligned to the global lateral direction 102. It is to be noted that the codes 44 are illustratively arranged on the container, and may be reproduced with different sizes.

In variant embodiments, which are not illustrated, other arrangements of the codes on the container are implemented, including: the oblique angle can be 20-70 degrees or 45 degrees±5% or ±10%; the second example code arrangement or other variants discussed here in are implemented on the container; the local longitudinal direction of the codes is aligned to the global longitudinal direction and the digital image is obtained by arranging it to be oblique to the global longitudinal direction.

In variant embodiments, which are not illustrated, the example arrangements are arranged on other containers, e.g. a capsule as shown in FIG. 8.

The code reading system 18 is configured to use the longitudinal edge 130 and/or lateral edge 132 for alignment when obtaining the digital image. For example, the code reading system 18 includes a container holder (not illustrated) to engage with said edges once the container 6 is received by the machine 2 in a code reading (image taking) position. In variant embodiments, the container holder is integrated as part of the processing unit.

### Digital Image

The code reading system 18 includes the previously discussed code reader 46 with an image capturing unit to capture a digital image of the code 44.

Referring to FIG. 17, the image capturing unit (not illustrated) of the code reading system 18 is configured to provide a digital image 96 of the codes 44 which is equal angular quadrilateral in shape and with equal side lengths (e.g. square). In FIG. 17 the boundary of the digital image 96 is shown for illustrative purposes. When viewed on the container 6 in this manner the digital image 96 is 5 mm×5 mm. Further reference to the size and shape of the digital image 96 is made in respect of it being idealised as on the container 6 in his manner.

The image capturing device includes a lens and an image sensor. The lens is circular and provides an image to the image sensor. The image sensor is equal angular quadrilateral to provide the discussed shape of digital image 96.

In variant embodiments, the image capturing device implements a square lens or square viewing window to provide said shape of digital image.

In variant embodiments, which are not illustrated, the shape of the digital image is different, including: equal angular quadrilateral in shape and with two equal side lengths (e.g. rectangular); with different dimension.

The quadrilateral of the digital image 96 is arranged oblique at the angle a to the quadrilateral 94 defined by the codes 44. In particular, the quadrilateral of the digital image 96 has a side length aligned to the global longitudinal direction 100 (which is aligned to the longitudinal edge 130).

Since the codes 44 are arranged with a local longitudinal direction 120 at 45 degrees to the global longitudinal direction 100, the quadrilateral 94 is also 45 degrees thereto.

The quadrilateral 94 defined by the codes 44 has a smaller side length than a slide length of the quadrilateral of the digital image 96, such that it can fit filly within the digital image 96 (although this condition is not illustrated for quadrilaterals 94 and 96). The side length of the quadrilateral of the digital image 96 twice that of an individual code 44.

In variant embodiments, which are not illustrated side length of the quadrilateral of the digital image is amounts other than twice that of an individual code, including 3 times.

With such an arrangement a maximum of 5 reference portions R1-R5 are fully located in the digital image 96 (i.e. the square idealising in the refence portion is entirely located in the image as illustrated). Fully located may refer to all units 84 that comprise the reference portion R being in said digital image 96. Moreover, if the digital image is alternatively positioned, as for digital image 98 a minimum of 2 reference portions R1, R2 are fully located in the digital image 96.

In this way a range of 2-5 reference portions R can always be used to locate a data portion of one of the codes 44 depending on where the digital image 96, 98 is taken. That is, the digital image 94 may be moved in any global longitudinal 100 or lateral 102 direction relative the codes 44 and the 2-5 reference portions R will away be achieved.

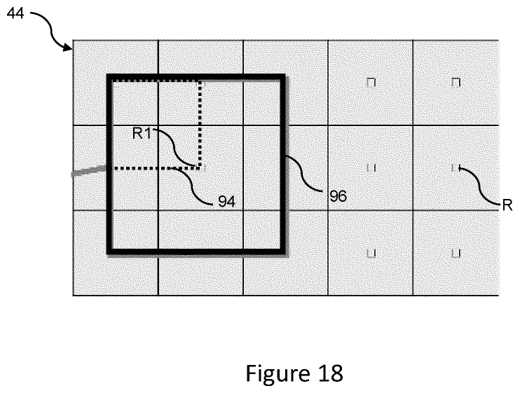

Referring to FIG. 18, if the quadrilateral of the digital image 96 and the quadrilateral 94 defined by the codes 44 are alternatively aligned to each other (e.g. with at least two or all edges, as shown, in alignment), there exist a condition where only a single reference portion R1 is arranged fully in the digital image 96.

With the embodiments discussed in association with FIGS. 16 and 17 the oblique angling of the quadrilaterals relative to each other avoids such situations. Beneficially more than one reference portion R can be used to more accurately locate a data portion D of one of the codes 44.

In variant embodiments, which are not illustrated, the codes are aligned to the global longitudinal direction on the container and the digital image is orientated oblique to said direction.

As discussed above, the electrical circuitry 16 is configured to locate at least one data portion D of a code 44 using said 2-5 reference portions R. By using a reference portion R of a code 44 for which a data portion D thereof is read together with at least one reference portion R of an adjoining code 44, said data portion D which is read may be located and therefore read with high accuracy.

In the example shown in FIG. 17: for the digital image 96 the 5 reference portions R1-R5 are located (which are at know positions relative to each other in the grid stricture) from which the single data portion D associated with the most central refence portion R1 in the digital image 96 is read; for the digital image 98 the 2 reference portions R1, R2 are located (which are at know positions relative to each other in the grid stricture) from which the two data portion D associated with the located refence portions R6, R7 in the digital image 98 are read.

The electrical circuitry 16 may implement various techniques for using multiple reference portions R to improve accuracy, for example: for three reference portions in a line, a line of best fit may be implemented along which the reference portions are assumed to sit; for three reference portions forming the quadrilateral 94 and angle may be corrected to 90 degrees for a square quadrilateral etc.

It will be understood that for the code 44 discussed in FIG. 11, since a value of a parameter is encoded as a distance d from a start position, the exact location of the start position in respect of the reference portion R effects the value of said parameter. Hence the implementation of more than one reference portion R for locating the data portion D can have an advantageous effect on the value of the parameter.

Whilst the or each code is illustrated herein as being arranged on the container, it will be appreciated that the code(s) can be formed integrally on the container or formed on a separate substrate (not illustrated) which can be attached to: the container, or; to the machine, e.g., as a tab for arrangement between the container and the code reader so that the existing code reading arrangement may be used, or; other component, e.g. including a hand held component that is arranged for a user to present to a code reader of the machine, which may be suitably arranged for manual code reading.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
   4 Machine
      14 Processing unit
         20 Container processing unit (first example)
            32 Extraction unit
            34 Capsule holding portion
            36 Closing portion
            38 Injection head
            40 Beverage outlet
         22 Fluid conditioning system
            24 Reservoir
            26 Pump
            28 Heat exchanger
            30 Outlet
         42 Loose material processing unit (second example)
      16 Electrical circuitry
         48 Control electrical circuitry
            50 Input unit
            52 Processor
            54 Feedback system
   18 Code reading system
      46 Image capturing unit
6 Container
   Capsule—Example 1
   56 Lid portion
      44 Code
         80 Units
            R Reference portion
            84 Reference units
            r Reference line
            O Origin
            D Data portion
            86 Data units
            E Encoding line
            d Distance
            88 Start position
            90 Discrete positions
            I Code Identifying portion
            94 Discrete position
            96 Identifying units
      82 Surround
         92 Outer periphery
   58 Containment portion
   60 Flange portion
   Packet—Example 2
   62 Sheet material
   64 Seams
   68 Opening
8 Server system
10 Peripheral device
12 Computer network

1. A system comprising:
a container for containing a precursor material for use with a machine for preparing a beverage and/or foodstuff or a precursor thereof, the container including a plurality of machine-readable codes, each code storing preparation information for use with a preparation process performed by the machine,
each code comprising a plurality of units defining a data portion arranged at a predetermined position with respect to a reference portion, the reference portions of adjoining codes arranged to define vertices of an equal angular quadrilateral with at least two equal sides;
the system further comprising the machine for preparing a beverage and/or foodstuff or a precursor thereof, the machine including:
a processing unit for processing precursor material of the container, and electrical circuitry to control the processing unit based on the preparation information read from the code, and;
a code reading system to read the code of the container by obtaining, with an image capturing device, a digital image of the code which is equal angular quadrilateral in shape;
wherein the container and the code reading system are configured to obtain the quadrilateral shaped digital image arranged oblique to the quadrilateral defined by the adjoining codes with the digital image to comprise at least two reference portions of the codes, with sides of the quadrilateral shaped digital image angled to the quadrilateral defined by the adjoining codes.

2. The system of claim 1, wherein the quadrilateral defined by the code has a smaller side length than a slide length of the quadrilateral shape of the digital image.

3. The system of claim 1, wherein each of the codes are arranged within a square planform, and the codes are arranged to adjoin each other.

4. The system of claim 3, wherein a vertex of a code is adjoined by either three or two other codes.

5. The system of claim 3, wherein a side length of the quadrilateral shape of the digital image is at least twice that of a side length of the code.

6. The system of claim 1, wherein the oblique arrangement comprises the quadrilateral defined by the codes arranged at 45 degrees to the quadrilateral shape of the digital image.

7. The system of claim 1, wherein the electrical circuitry is configured to locate at least one data portion in the digital image using the at least two reference portions.

8. The system of claim 1, wherein the quadrilateral of the digital image and the quadrilateral defined by the codes are configured such that if aligned to each other, only a single reference portion may be arranged in the digital image.

9. The system of claim 1, wherein the quadrilateral defined by the adjoining codes is arranged oblique to an edge of the container, which the code reading system is configured to use for alignment when obtaining the digital image.

10. A machine for preparing a beverage and/or foodstuff or a precursor thereof, the machine including:
a code reading system to read a codes of a container;
a processing unit for processing precursor material of the container;
electrical circuitry to control the processing unit based on preparation information read from the code,
with each code comprising a plurality of units defining a data portion arranged at a predetermined position with respect to a reference portion, the reference portions of adjoining codes arranged to define vertices of an equal angular quadrilateral with at least two equal sides; and
a code reading system to read the code of the container by obtaining, with an image capturing device, a digital image of the code which is equal angular quadrilateral in shape;
wherein the container and the code reading system are configured to obtain the quadrilateral shaped digital image arranged oblique to the quadrilateral defined by the adjoining codes with the digital image to comprise at least two reference portions of the codes, with sides of the quadrilateral shaped digital image angled to the quadrilateral defined by the adjoining codes.

11. A container for containing a precursor material for use with a machine for preparing a beverage and/or foodstuff or a precursor thereof, the container including a plurality of machine-readable codes, each code storing preparation information for use with a preparation process performed by the machine,
each code comprising a plurality of units defining a data portion arranged at a predetermined position with respect to a reference portion, the reference portions of adjoining codes arranged to define vertices of an equal angular quadrilateral with at least two equal sides,
wherein the quadrilateral defined by the adjoining codes is arranged oblique to an edge of the container.

12. (canceled)

13. A method of determining preparation information for a beverage or foodstuff preparation process, the method comprising:
with an arrangement of codes on a container, the codes encoding preparation information and having reference portions for location of a data portion arranged to define vertices of an equal angular quadrilateral with at least two equal sides;
obtaining a digital image of the codes which is equal angular quadrilateral in shape and is arranged oblique to the quadrilateral defined by the codes, with sides of the quadrilateral shaped digital image angled to the quadrilateral defined by the adjoining codes;
identifying at least two reference portions in the digital image;
locating at least one data portion using the at least two reference portions; and
reading the data from the at least one located data portion.

14. Electrical circuitry configured to implement the method of claim 13.

15. A computer readable medium comprising program code executable on one or more processors to implement the method of claim 13.
